(19) United States
(12) Patent Application Publication
(10) Pub. No.: US 2019/0196875 A1
(43) Pub. Date: Jun. 27, 2019

(54) METHOD, SYSTEM AND COMPUTER PROGRAM PRODUCT FOR PROCESSING COMPUTING TASK

(71) Applicant: EMC IP Holding Company LLC, Hopkinton, MA (US)

(72) Inventors: Junping Zhao, Beijing (CN); Zhi Ying, Shanghai (CN)

(21) Appl. No.: 16/173,039

(22) Filed: Oct. 29, 2018

(30) Foreign Application Priority Data
Oct. 27, 2017 (CN) CN 201711022430.3

(51) Int. Cl. G06F 9/50; H04L 29/08

(52) U.S. Cl. CPC G06F 9/5027; H04L 67/141

(57) ABSTRACT

The present disclosure relates to a method, system and computer program product for processing a computing task. There is provided a method for processing a computing task, comprising: establishing a connection with a client in response to receiving a processing request from the client, the processing request being for requesting an allocation of a set of computing resources for processing the computing task; receiving a set of resource calling instructions associated with the computing task from the client via the established connection; executing the set of resource calling instructions to obtain a processing result by using the set of computing resources; and returning the processing result to the client. Further, there is provided a method for processing a computing task, comprising: establishing a connection with a server on the basis of a processing request, the processing request being for requesting the allocation of a set of computing resources for processing the computing task; executing the computing task, comprising: extracting a set of resource calling instructions from the computing task; sending the set of resource calling instructions to the server via the established connection; and receiving from the server a processing result of executing the set of resource calling instructions by the set of computing resources. Still further, there is provided a corresponding system and computer program product.

### RELATED APPLICATIONS

This application claim priority from Chinese Patent Application Number CN 201711022430.3, filed on Oct. 27, 2017 at the State Intellectual Property Office, China, titled “METHOD, SYSTEM AND COMPUTER PROGRAM PRODUCT FOR PROCESSING COMPUTING TASK” the contents of which is herein incorporated by reference in its entirety.

### FIELD

Various implementations of the present disclosure relate to processing a computing task, and more specifically, to a method and apparatus for processing a computing task remotely, as well as a computer program product.

### BACKGROUND

With the development of computing techniques and network techniques, heavy computing workloads related to applications are no longer executed at a local client computing device but may be loaded to a remote computing device at other position. At this point, how to provide a more convenient and effective approach to process computing tasks remotely becomes a focus of research.

### SUMMARY

Therefore, it is desirable to develop and implement a technical solution for providing remote calling of computing resources more easily and effectively. It is desired that the technical solution can be compatible with existing systems and provide remote calling of computing resources more easily and effectively without changing existing operations of users as much as possible.

In one implementation of the present disclosure, there is provided a method for managing computing resources. The method comprises: establishing a connection with a client in response to receiving a processing request from the client, the processing request being for requesting an allocation of a set of computing resources for processing to computing task; receiving a set of resource calling instructions associated with the computing task from the client via the established connection; executing the set of resource calling instructions to obtain a processing result by using the set of computing resources; and returning the processing result to the client.

In one implementation of the present disclosure, there is provided a system for managing computing resources, comprising: one or more processors; a memory coupled to at least one processor of the one or more processors; computer program instructions stored in the memory which, when executed by the at least one processor, cause the system to execute a method for managing computing resources. The method comprises: establishing a connection with a client in response to receiving a processing request from the client, the processing request being for requesting an allocation of a set of computing resources for processing the computing task; receiving a set of resource calling instructions associated with the computing task from the client via the established connection; executing the set of resource calling instructions to obtain a processing result by using the set of computing resources; and returning the processing result to the client.

In one implementation of the present disclosure, there is provided a method for processing a computing task. The method comprises: establishing a connection with a server on the basis of a processing request, the processing request being for requesting the allocation of a set of computing resources for processing the computing task; executing the computing task, comprising: extracting a set of resource calling instructions from the computing task; sending the set of resource calling instructions to the server via the established connection; and receiving from the server a processing result of executing the set of resource calling instructions by the set of computing resources.

In one implementation of the present disclosure, there is provided a system for managing computing resources, comprising: one or more processors; a memory coupled to at least one processor of the one or more processors; computer program instructions stored in the memory which, when executed by the at least one processor, cause the system to execute a method for managing computing resources. The method comprises: establishing a connection with a server on the basis of a processing request, the processing request being for requesting the allocation of a set of computing resources for processing the computing task; executing the computing task, comprising: extracting a set of resource calling instructions from the computing task; sending the set of resource calling instructions to the server via the established connection; and receiving from the server a processing result of executing the set of resource calling instructions by the set of computing resources.

In one implementation of the present disclosure, there is provided an apparatus for managing computing resources.

In one implementation of the present disclosure, there are provided computer program instructions which, when executed by at least one processor, cause the at least one processor to execute a method for managing computing resources as described above.

With the technical solution of the present disclosure, where data copies in computing resources are reduced, a storage system may be converted from a first type to a second type more rapidly.

### BRIEF DESCRIPTION OF THE SEVERAL VIEWS OF THE DRAWINGS

Through the more detailed description in the accompanying drawings, the above and other objects, features and advantages of the implementations of the present invention will become more apparent. Several implementations of the present invention are illustrated schematically and are not intended to limit the present invention. In the drawings:

FIG. 1 schematically illustrates a block diagram of an exemplary computer system which is applicable to implement the implementations of the present disclosure;

FIG. 2 schematically illustrates a block diagram of the process for processing a computing task according to one technical solution;

FIG. 3 schematically illustrates a block diagram of the process for processing a computing task according to one implementation of the present disclosure;

FIG. 4 schematically illustrates a flowchart of a method for processing a computing task according to one implementation of the present disclosure;

FIGS. 5A and 5B schematically illustrate a block diagram of the process for processing a computing task by different computing resources according to the implementations of the present disclosure respectively;

FIG. 6 schematically illustrates a block diagram of processing different resource calling instructions by different computing resources according to one implementation of the present disclosure;

FIGS. 7A and 7B schematically illustrate a schematic view of a state of computing resources for processing a computing task according to the implementations of the present disclosure respectively;

FIG. 8 schematically illustrates a block diagram of the process for processing a computing task according to one implementation of the present disclosure; and

FIGS. 9A and 9B schematically illustrate a block diagram of an apparatus for processing a computing task according to the implementations of the present disclosure, respectively.

### DETAILED DESCRIPTION

Some preferable implementations will be described in more detail with reference to the accompanying drawings, in which the preferable implementations of the present disclosure have been illustrated. However, the present disclosure can be implemented in various manners, and thus should not be construed to be limited to the implementations disclosed herein. On the contrary, those implementations are provided for the thorough and complete understanding of the present disclosure, and completely conveying the scope of the present disclosure to those skilled in the art.

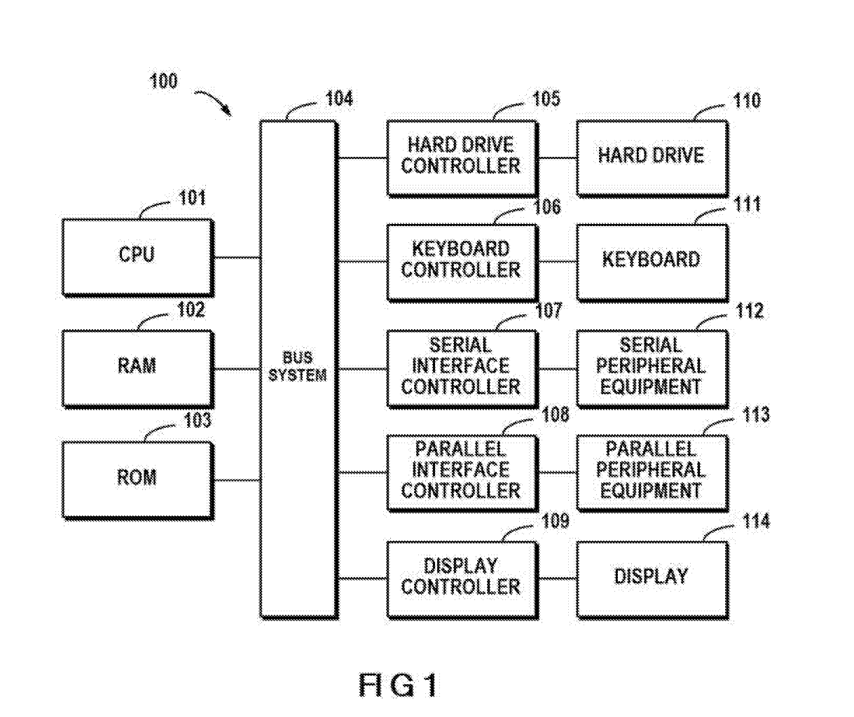

FIG. 1 illustrates an exemplary computer system 100 which is applicable to implement the implementations of the present invention. As illustrated in FIG. 1, the computer system 100 may include: CPU (Central Process Unit) 101, RAM (Random Access Memory) 102, ROM (Read Only Memory) 103, System Bus 104, Hard Drive Controller 105, Keyboard Controller 106, Serial Interface Controller 107, Parallel Interface Controller 108, Display Controller 109, Hard Drive 110, Keyboard 111, Serial Peripheral Equipment 112, Parallel Peripheral Equipment 113 and Display 114. Among above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105. Keyboard 111 is coupled to Keyboard Controller 106. Serial Peripheral Equipment 112 is coupled to Serial Interface Controller 107. Parallel Peripheral Equipment 113 is coupled to Parallel Interface Controller 108. And, Display 114 is coupled to Display Controller 109. It should be understood that the structure as illustrated in FIG. 1 is only for the exemplary purpose rather than any limitation to the present invention. In some cases, some devices may be added to or removed from the computer system 100 based on specific situations.

As will be appreciated by one skilled in the art, aspects of the present invention may be embodied as a system, method or computer program product. Accordingly, aspects of the present invention may take the form of an entirely hardware implementation, an entirely software implementation (including firmware, resident software, micro-code, etc.) or one implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to implementations of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

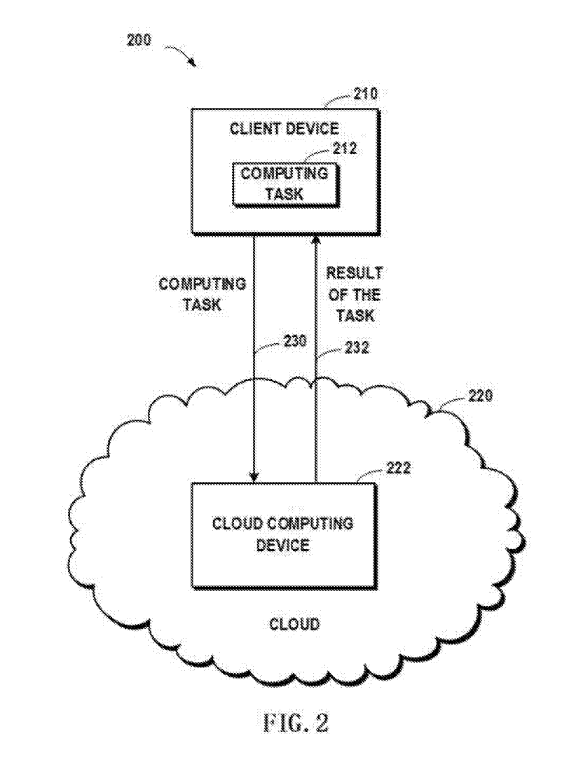

With the development of cloud computing, there have been proposed technical solutions for processing computing tasks on the basis of cloud architecture. FIG. 2 schematically shows a block diagram 200 of the process for processing a computing task 212 according to one technical solution. As shown in FIG. 2, a client device 210 may be a user's local computing device (e.g. a desktop computer or a laptop computer, etc.), and the computing task 212 is running on the client device 210. To enable a cloud computing device 222 to process the computing task 212, as shown by an arrow 230, the computing task 212 is sent from the client device 210 to a computing device 222 in the cloud 220. Subsequently, the cloud computing device 222 may process the computing task 212 by using its own computing resources. After the end of the processing, as shown by an arrow 232, a result of performing the computing task 212 is returned to the client device 210.

With the development of computer techniques, computing resources get increasingly abundant and are no longer limited to traditional ones, such as central processing units. For example, the computing capability of current graphic processing units (GPUs) becomes more and more powerful. By virtue of GPUs' distinctive properties, GPUs are particularly applicable to perform computing tasks in deep learning, high performance computing, machine learning and other fields. However, for the common client device 210 and the conventional cloud computing device 222, their graphic processing units only have a limited performance and lack high performance processing power. At this point, it becomes a focus of research regarding how to process computing tasks by using the computing capability of a graphic processing unit of other device (remotely, for example).

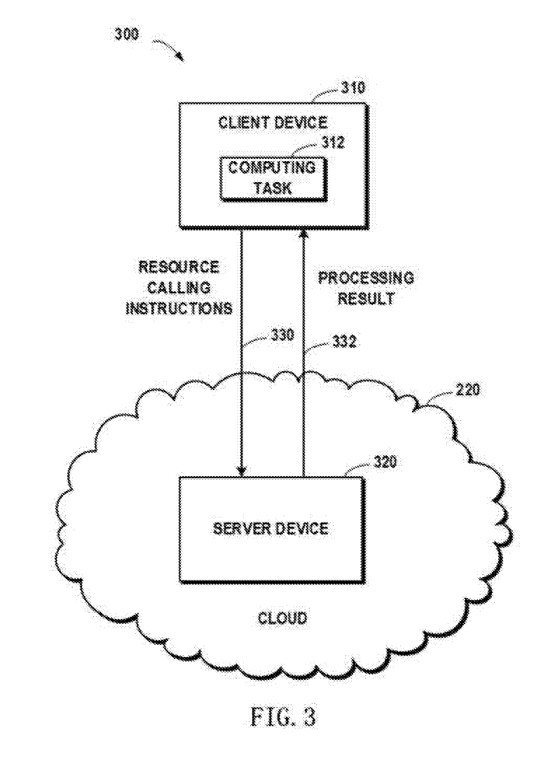

To solve the foregoing problem, according to one implementation of the present disclosure, there is provided a method for processing a computing task. FIG. 3 schematically shows a block diagram 300 of the process for processing a computing task according to one implementation of the present disclosure. As shown in FIG. 3, a computing device 312 is running on a client device 310. A server device 320 is a computing device remote from the client device 310. The server device 320 is in the cloud 220 for example, or may communicate with the client device 310 in other way.

In this application environment, when the computing task 312 comprises resource calling instructions (e.g. GPU executable instructions) on the graphic processing unit, as shown by an arrow 330, these resource calling instructions may be sent to the remote server device 320 (e.g. in the cloud 220). Subsequently, the resource calling instructions are executed by a set of computing resources (e.g. GPU) at the server device 320. Next, as shown by an arrow 332, a processing result is returned to the client device 310.

Note according to one implementation of the present disclosure, the computing task 312 running on the client device 310 does not need to be modified or transferred to the server device 320, but only GPU related instructions need to be extracted from the computing task 312 and sent to the server device 320 for processing. In this way, on the one hand, the computing task 312 that used to be executed by a computing device with a high performance GPU may run on the client device 310 (the client device 310 may have no GPU or only have a low performance GPU). On the other hand, the process of running the computing task 312 is transparent to the client device 310 and its users. In other words, there is no need to modify the computing task 312, or know where the GPU that executes resource calling instructions from the computing task 312 is located physically.

Specifically, according to one implementation of the present disclosure, there is provided a method for processing the computing task 312. The method comprises: in response to receiving a processing request from a client, establishing a connection with the client, the processing request being used for requesting the allocation of a set of computing resources for processing the computing task 312; receiving a set of resource calling instructions associated with the computing task 312 from the client via the established connection; executing the set of resource calling instructions to obtain a processing result by using the set of computing resources; and returning the processing result to the client.

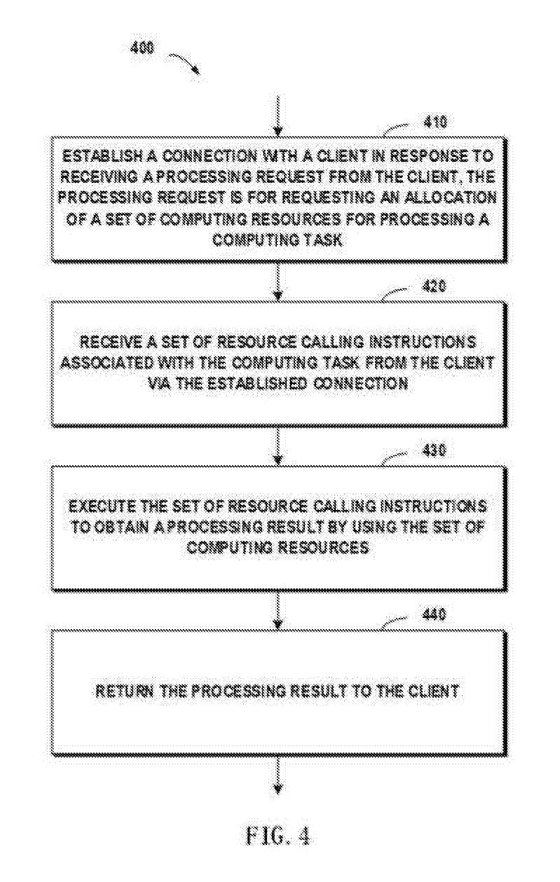

FIG. 4 schematically shows a flowchart of a method 400 for processing the computing task 312 according to one implementation of the present disclosure. The method 400 may be executed at server side. Specifically, at a block 410, in response to receiving a processing request from a client, a connection is established with the client, the processing request being used for requesting the allocation of a set of computing resources for processing the computing task 312. At this point, on the basis of a processing request from a client, the client may establish a connection with a server so that communication between the server and the client may be carried out on the basis of the connection in subsequent operation.

At a block 420, a set of resource calling instructions associated with the computing task 312 are received from the client via the established connection. Here the set of resource calling instructions may be extracted by the client from the computing task 312. Compared with existing cloud-based techniques, according to one implementation of the present disclosure, the entire computing task 312 does not need to be sent to the server, but only a set of resource calling instructions need to be received at the server from the client. It will be appreciated the set of resource calling instructions here may further comprise to-be-processed data involved in the instructions. For example, the computing task 312 on deep learning functions to obtain a processing result about image content classification from a series of inputted image data. Then at this point, the set of resource calling instructions may comprise GPU instructions and inputted image data.

At a block 430, the set of resource calling instructions are executed to obtain a processing result by using the set of computing resources. A computing resource pool of computing resources (e.g. GPUs) usable by the outside may be deployed at the server device 320, so that these GPUs may execute the received set of resource calling instructions so as to obtain a processing result. Continuing the foregoing example about deep learning, at this point the received resource calling instructions may be executed so as to obtain a processing result about image content classification, by using computing resources in the computing resource pool.

In a block 440, the processing result is sent to the client. Note at this point, the processing result may be a processing result of executing the entire computing task 312 or a processing result of one or more stages in executing the entire computing task 312. For example, after completing one stage in executing the computing task 312, operation in subsequent stages may be executed on the basis of a processing result of this stage according to the implementation of the present disclosure. Specifically, a further set of resource calling instructions associated with a subsequent stage may be received at the client, and the further set of resource calling instructions may be executed by the computing resources to obtain a corresponding processing result, which is ignored here.

Note, the client here may refer to a client program running on the client device 310, and the server may refer to a server program running on the server device 320. It will be appreciated according to other implementations of the present disclosure, the client program and the server program may run on other devices. For example, the client program may run on other device coupled to the client device 310 via a link. At this point, the client program may obtain via the link resource calling instructions generated by the computing task 312 and send the same to the server program. Alternatively or additionally, the server program may run on other device coupled to the server device 320 via a link. At this point, the server program may schedule computing resources in the server device 320 via the link.

According to one implementation of the present disclosure, to make it convenient for the client to establish a connection with the server, connection configuration available to the processing request may be provided to the client on the basis of resource configuration information. The resource configuration information here refers to description of computing resources which may be provided to the outside. For example, where computing resources are GPUs, the resource configuration information may comprise various information about the accessible GPUs. For example, there may be comprised a protocol used for establishing a connection, login information (e.g. account number, password, etc.), a device index (e.g. number of a GPU, etc.) providing computing resources, and use state (e.g. idle, occupied) of computing resources.

At this point, available connection configuration may be returned to the client on the basis of situation of computing resources that can provide service to the outside. For example, suppose there exist 12 accessible GPUs in the computing pool, whereas 4 of the 12 GPUs have been occupied, then at this point connection configuration comprising information on the other 8 GPUs may be returned to the client. One example of connection configuration is illustrated in Table 1 below.

TABLE 1
Example of Connection Configuration

| Name | Content | Description |
|---|---|---|
| Connection | Protocol type: TCP | Basic information for connecting |
| information | IP address: XXX | to server device |
| | Port number: YYY | |
| Login information | Account: AAA | Account information for logging |
| | Password: BBB | into server device |
| Index of device | GPU0-GPU7 | Index of accessible computing |
| | | resources in server device |

As shown in Table 1, the first column lists names of different aspects of connection configuration, the second column lists specific contents, and the third column lists relevant description. Specifically, connection configuration in Table 1 indicates: the client may carry out a connection with an IP address of XXX and a port number of YYY on the basis of TCP protocol, and the login account is AAA with a password of BBB. At this point, available computing resources comprise 8 GPUs, i.e. GPU0 to GPU7.

Next, the connection is established in response to the client initiating a connection request on the basis of the connection configuration. At this point, the client may initiate a connection request on the basis of information in the connection configuration. Specifically, the client may carry out a connection on the basis of the connection configuration in Table 1 above. For example, after login, an appropriate number of GPUs may be selected from the 8 available GPUs.

According to one implementation of the present disclosure, the resource configuration information may further comprise other information. For example, the resource configuration information may record additional information of each GPU, such as computing performance, brand name, utilization efficiency, etc. When the processing request comprise a demand on the set of computing resources, computing resources matching the demand may be selected from the resource configuration information as the set of computing resources. For example, the demand may specify the desired computing performance is higher than that of a GPU at a given level, or may further specify the desired brand name of a GPU. At this point, a set of computing resources matching the demand may be selected on the basis of the foregoing additional information in the resource configuration information, and then connection configuration needed for connecting the set of matching computing resources may be returned, so that the client may carry out a connection on the basis of the connection configuration.

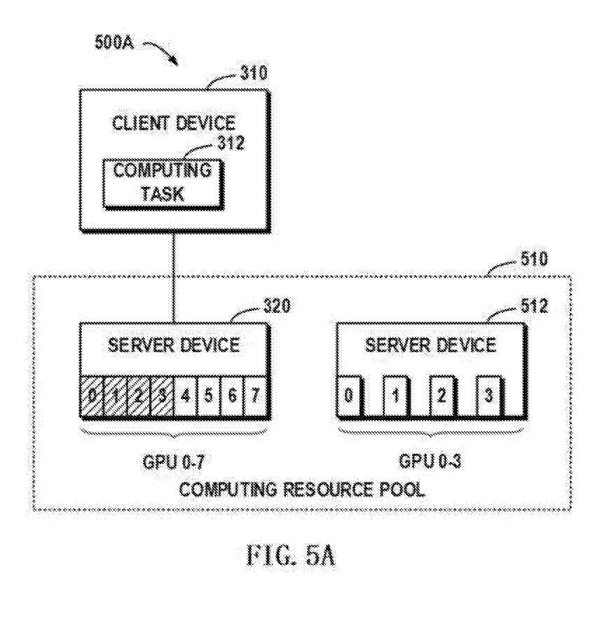

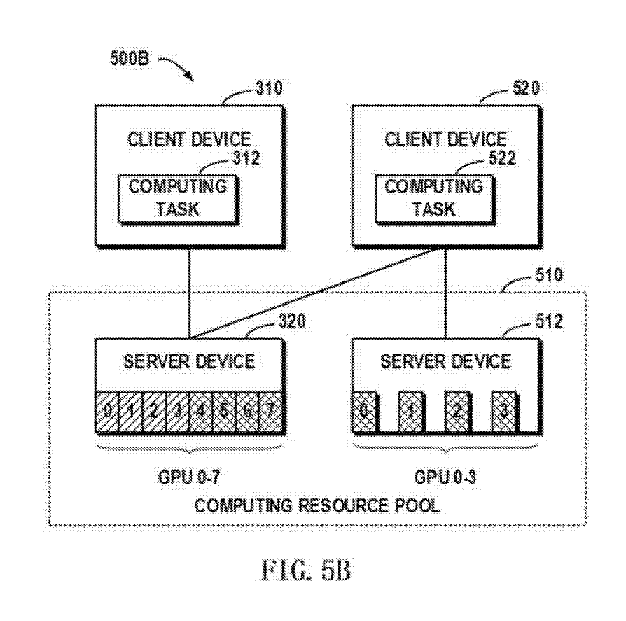

FIG. 5A schematically shows a block diagram 500A of the process for processing a computing task by different computing resources according to one implementation of the present disclosure. As shown in FIG. 5A, a computing resource pool 510 involves the server device 320 and a server device 512, wherein 8 GPUs (GPU0 to GPU7) are deployed on the server device 320, and 4 GPUs (GPU0 to GPU3) are deployed on the server device 512.

It will be appreciated although FIG. 5A shows a circumstance where the computing resource pool 510 comprises the server devices 320 and 512 on which GPUs are deployed. Here, the computing resource pool 510 is a logical concept. The GPU in the computing resource pool 510 refers to a GPU which can be allocated to the outside for executing resource calling instructions, and the GPU is deployed on a physical server device which can be accessed and scheduled by a server. Throughout the context of the present disclosure, it is not intended to limit the physical position of the GPU, so long as the server may access the GPU and use the same to execute resource calling instructions.

Suppose the client device 310 desires to use 4 GPUs in the resource pool 510 to process the computing task 312, at this point the processing request received on the server end may request the allocation of 4 GPUs. Suppose all GPUs in the resource pool 510 are in idle state, then the connection configuration may comprise information on all available GPUs (i.e. 8+4=12 GPUs). The client device 310 may select 4 (e.g. GPU0 to GPU3 on the server device 320) of the GPUs and build a connection, so that GPU0 to GPU3 (as shown by slash areas in FIG. 5A) may execute the resource calling instructions extracted from the computing task 312.

FIG. 5B schematically shows a block diagram 500B of the process for processing a computing task by different computing resources according to one implementation of the present disclosure. FIG. 5B shows the situation after the client device 310 establishes a connection. The other client device 520 desires to use GPUs in the resource pool 510 to perform a computing task 522. Suppose a processing request from the client device 520 requests the allocation of 8 GPUs, since GPU0 to GPU3 on the server device 320 have been occupied, at this point the returned connection configuration may comprise information on only GPU4 to GPU7 on the server device 320 and GPU0 to GPU3 on the server device 512. Subsequently, the client device 520 may be connected to 8 available GPUs on the basis of the connection configuration, so that the 8 GPUs (as shown by hatched areas in FIG. 5B) may execute resource calling instructions extracted from the computing task 522.

It will be appreciated GPU resources in the computing resource pool 510 may be expanded or shrunk. According to one implementation of the present disclosure, in response to receiving an expansion request for adding a new computing resource, information associated with the new computing resource is added to the resource configuration information. Suppose it is desirable to add GPU0 to GPU8 in a new server device to the computing resource pool 510, information associated with GPU0 to GPU8 in a new server device may be added to the resource configuration information used for the computing resource pool 510 on the basis of various contents in the resource configuration information as described above.

Specifically, suppose the new server device may be connected using the Remote Direct Memory Access (RDMA) protocol, and the following information may be added to “Connection Information” in the resource configuration information:

Protocol type: RDMA

IP address: CCC

Port number: DDD

Suppose the new server device may be logged into using an account EEE and a password FFF, and the following may be added to “login information” in the resource configuration information:

Account: EEE

Password: FFF

Suppose global unique indexes of GPUs in the new server device are GPU300 to GPU307 respectively, then GPU300-GPU307 may be added to “index of device” in the resource configuration information.

According to one implementation of the present disclosure, in response to receiving a removal request for removing an existing computing resource, information associated with the existing computing resource may be removed from the resource configuration information. While an example regarding how to add a computing resource to the computing resource pool has been described above, description is presented below to how to remove a computing resource from the computing resource pool 510. For example, if it is desirable to delete all computing resources involved in the new server device that have been added in the foregoing example, then the “connection information,” “login information” and “index of device” described above may be deleted from the resource configuration information.

According to one implementation of the present disclosure, the set of resource calling instructions received from the client may be divided into multiple sub-sets on the basis of performance demands from various resource calling instructions in the set of resource calling instructions, and subsequently different sub-sets may be executed by different portions of the computing resources. Note the dividing here may be performed by the client or may further be executed by the server.

According to one implementation of the present disclosure, the client may execute the division and specify which portion of the computing resources processes each sub-set. Subsequently, the server may receive from the client multiple sub-sets of the set of resource calling instructions and a mapping relationship therebetween. Here, the multiple sub-sets are based on performance demands from various resource calling instructions in the set of resource calling instructions, and the mapping relationship specifies a mapping relationship between a sub-set among the multiple sub-sets and a corresponding portion of the set of computing resources. On the basis of the mapping relationship, it may be determined which computing resource(s) execute resource calling instructions in various sub-sets. According to one implementation of the present disclosure, after the server receives a set of resource calling instructions from the client, the server may divide these resource calling instructions into sub-sets and specify which portion of the computing resource processes each sub-set.

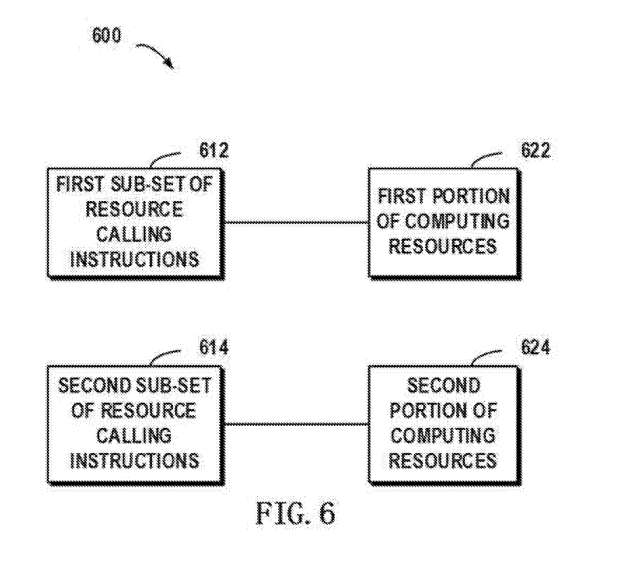

FIG. 6 schematically shows a block diagram 600 of a mapping relationship for processing different resource calling instructions by different computing resources according to one implementation of the present disclosure. Specifically, a set of resource calling instructions associated with a computing task may be divided into a first sub-set 612 and a second sub-set 614. A mapping relationship may, for example, specify a first portion 622 of the computing resources process the first sub-set 612 and a second portion 624 of the computing resources process the second sub-set 614.

Continuing the foregoing example, in the computing task 312 of deep learning, suppose the computing task 312 desires to make statistics on the number of images whose contents are persons from a series of inputted images. At this point, resource calling instructions involved in the computing task 312 might be divided into two sub-sets: 1) judging whether the content of each image is a person; and 2) making statistics on the total number of images whose contents are persons. Since the sub-set 1 might involve a large amount of computation, the sub-set 1 may be mapped to one or more high-performance GPUs. In addition, since the sub-set 2 only relates to simple computation, the sub-set 2 may be mapped to an ordinary-performance GPU. In this implementation, since computing resources are allocated to different resource calling instructions on the basis of the instructions' demands on computing resources, the allocation of computing resources may be scheduled more effectively.

According to one implementation of the present disclosure, a sub-set among the multiple sub-sets may be executed to obtain a processing sub-result by using a corresponding portion in the set of computing resources on the basis of the mapping relationship. Subsequently, the processing result is obtained on the basis of the processing sub-result. Hence, by executing resource calling instructions in various sub-sets by different GPUs, the computing task 312 may be processed in a more effective and balanced way. On the one hand, it may be guaranteed each computing resource in the computing resource pool 510 may fulfill its own computing performance; on the other hand, it may further be guaranteed a balance of workloads is stricken between various computing resources.

According to one implementation of the present disclosure, the computing resources are graphic processing units, and the set of resource calling instructions are instructions executable to the graphic processing units. It will be appreciated although specific implementations of the present disclosure have been described by taking GPUs as a specific example of computing resources, with advances in computer technologies, the present disclosure may further be applied to other processing units to be developed in future.

According to one implementation of the present disclosure, workloads of various computing resources in the computing resource pool 510 may be monitored, and the various computing resources may be dynamically scheduled on the basis of the workloads. Specifically, when the workload of a set of computing resources exceeds a predefined threshold, the set of resource calling instructions may be dynamically allocated to a further set of computing resources. Subsequently, the further set of computing resources executes the set of resource calling instructions to obtain a processing result.

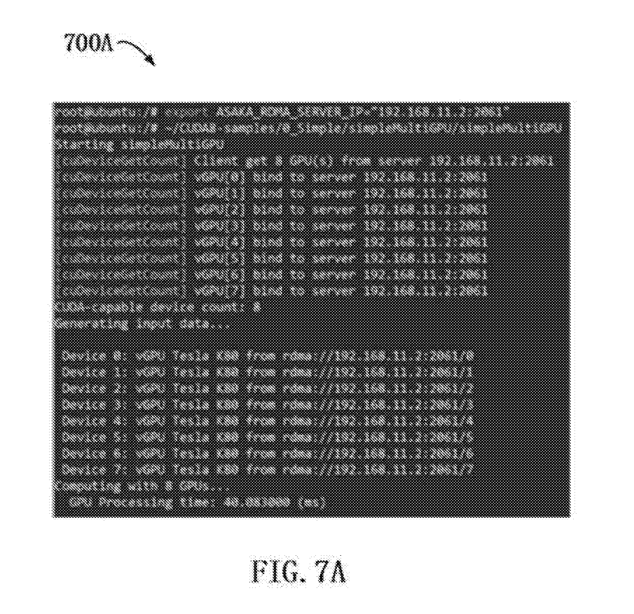

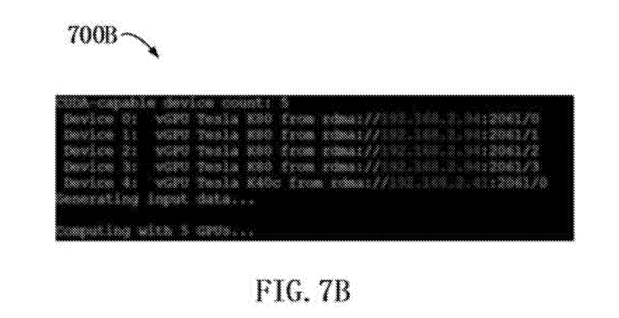

According to one implementation of the present disclosure, statistical information on computing resources may further be generated. For example, statistics may be made on any of: the number of the set of computing resources, a time duration for which the at least one set of computing resources has been used, and a workload of the set of computing resources. FIGS. 7A and 7B show schematic views 700A and 700B of states of computing resources for processing a computing task according to the implementations of the present disclosure. As depicted in FIG. 7A, this figure shows one client device accesses statistical information of 8 GPUs (i.e., GPU0 to GPU7) in the computing resource pool via the RDMA protocol so as to execute the computing task 312. With reference to FIG. 7B, this figure shows two client devices separately access statistical information of GPUs in the computing resource pool, wherein a first client device utilizes 4 GPUs and a second client device utilizes 1 GPU.

Further, the provider of the server device 320 may charge or perform other operations to a user of the client device 310 on the basis of the statistical information. According to one implementation of the present disclosure, a priority may further be set to the processing request. Next, the set of computing resources may be utilized on the basis of the determined priority.

Specific details of the method executed at a server have been described with reference to figures. Hereinafter, detailed description will be presented to various processing performed at a client. According to one implementation of the present disclosure, there is provided a method for processing a computing task 312. First of all, a connection is established with a server on the basis of a processing request, which is for requesting the allocation of a set of computing resources for processing the computing task 312. The computing task 312 may be executed at the client. Specifically, a set of resource calling instructions is extracted from the computing task 312. The set of resource calling instructions is sent to the server via the established connection. Finally, a processing result of executing the set of resource calling instructions by the set of computing resources is received from the server.

In this implementation, the client does not have to transfer the entire computing task 312 to the server, but only extracts from the computing task 312 instructions to be executed by the computing resources like GPUs and sends these instructions to the server. In this way, only by adding a client application at the client device 310 or other device capable of accessing the client device 310, remote computing resources can be called to execute the computing task 312. In this way, there is no need to modify the computing task 312 that used to run at the client device 310. Therefore, according to the implementation of the present disclosure, the process of remote calling computing resources by the client is transparent to the user of the client device 310. Thereby, the computing task 312 may be processed more easily and effectively.

According to one implementation of the present disclosure, the client may send the processing request to the server on the basis of computing resources needed by the computing task 312. Subsequently, in response to receiving from the server a connection configuration available to the processing request, the connection is established with the server on the basis of the connection configuration.

According to one implementation of the present disclosure, the client may perform division and specify a mapping relationship. Specifically, the client may divide the set of resource calling instructions into multiple sub-sets on the basis of demands on performance from various resource calling instructions in the set of resource calling instructions. Subsequently, a mapping relationship between a corresponding sub-set among the multiple sub-sets and a corresponding portion in the set of computing resources may be determined on the basis of the connection configuration.

According to one implementation of the present disclosure, the client may send the set of resource calling instructions to the server. Specifically, the client may send a corresponding sub-set among the multiple sub-sets and the mapping relationship to the server, so that a corresponding portion in the set of computing resources executes the corresponding sub-set among the multiple sub-sets on the basis of the mapping relationship.

According to one implementation of the present disclosure, the processing request comprises a demand on the set of computing resources so as to select the set of computing resources that match the demand. At the server end, a set of appropriate computing resources may be selected on the basis of the demand.

According to one implementation of the present disclosure, the computing resource is a graphical processing unit, and the set of resource calling instructions is instructions executable to the graphical processing unit.

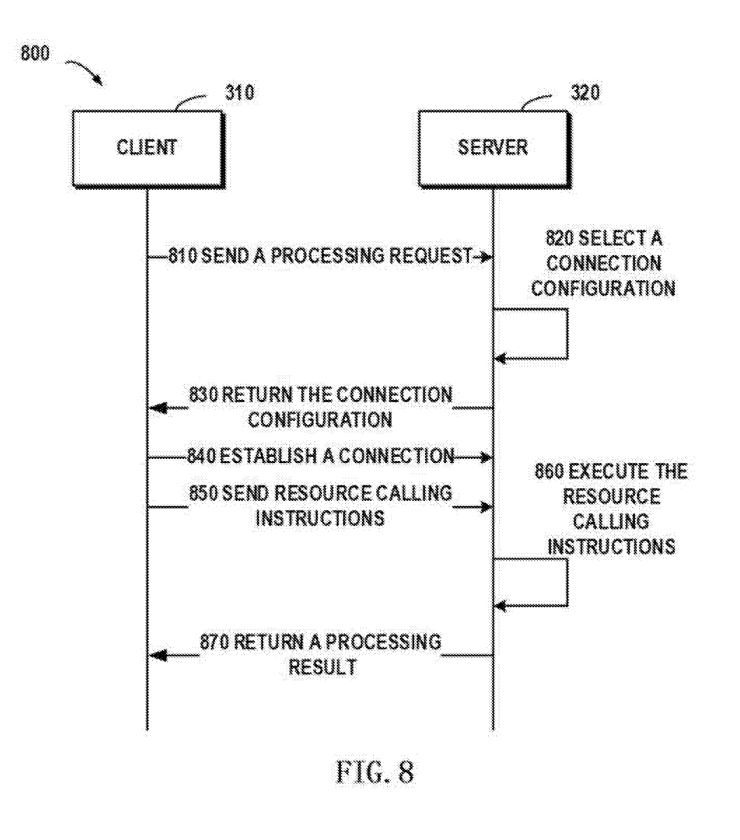

FIG. 8 schematically shows a block diagram 800 of the process of processing a computing task 312 according to one implementation of the present disclosure. In FIG. 8, as shown by an arrow 810, the client device 310 may send to the server device 320 a processing request, which is for requesting a server to allocate a set of computing resources for processing the computing task 312. As shown by an arrow 820, the server device 320 may select computing resources available to the client device 310 on the basis of the processing request. As shown by an arrow 830, a corresponding connection configuration is returned to the client device 310. Next as shown by an arrow 840, the client device 310 may establish a connection with the server device 320. As shown by an arrow 850, the client device 310 may send a set of resource calling instructions (e.g., instructions to be executed by GPUs) associated with the computing task 312 to the server device 320. As shown by an arrow 860, the server device 320 may execute received resource calling instructions. Subsequently as shown by an arrow 870, a processing result may be returned to the client device 310.

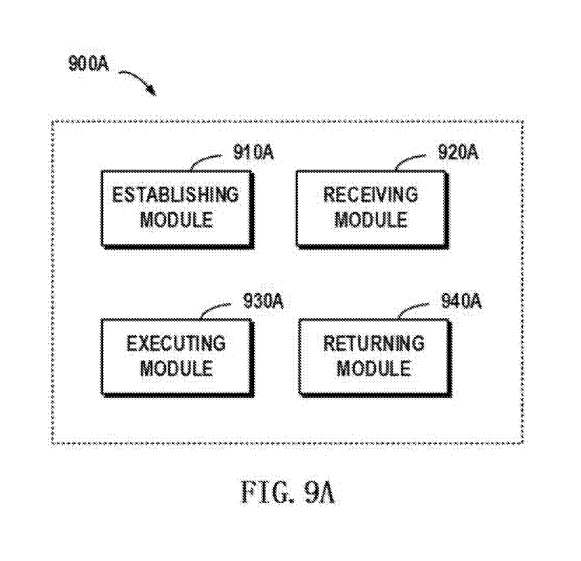

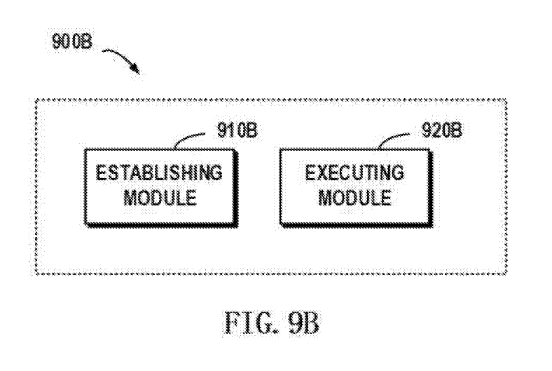

FIG. 9A schematically shows a block diagram of an apparatus 900A for processing a computing task according to one implementation of the present disclosure. Specifically, the apparatus 900A comprises: an establishing module 910A configured to establish a connection with a client in response to receiving a processing request from the client, the processing request being for requesting an allocation of a set of computing resources for processing the computing task; a receiving module 920A configured to receive a set of resource calling instructions associated with the computing task from the client via the established connection; an executing module 930A configured to execute the set of resource calling instructions to obtain a processing result by using the set of computing resources; and a returning module 940A configured to return the processing result to the client.

According to one implementation of the present disclosure, the establishing module 910A is further configured to: provide to the client a connection configuration available to the processing request on the basis of resource configuration information; and establish the connection in response to a connection request initiated by the client on the basis of the connection configuration.

According to one implementation of the present disclosure, the processing request comprises a demand on the set of computing resources. The establishing module 910A is further configured to: select computing resources that match the demand from the resource configuration information as the set of computing resources; and provide to the client a connection configuration for accessing the set of computing resources.

According to one implementation of the present disclosure, the device 900A further comprises an updating module configured to: in response to receiving an expansion request for adding a new computing resource, add information associated with the new computing resource to the resource configuration information; and in response to receiving a removal request for removing an existing computing resource, remove information associated with the existing computing resource from the resource configuration information.

According to one implementation of the present disclosure, the receiving module 940 is further configured to receive multiple sub-sets of the set of resource calling instructions as well as a mapping relationship from the client, the multiple sub-sets being divided based on demands on performance from various resource calling instructions in the set of resource calling instructions, the mapping relationship specifying a mapping relationship between a corresponding sub-set among the multiple sub-sets and a corresponding portion in the set of computing resources.

According to one implementation of the present disclosure, the receiving module 940 is further configured to: divide the set of resource calling instructions received from the client into multiple sub-sets on the basis of demands on performance from various resource calling instructions in the set of resource calling instructions; specify a mapping relationship between a corresponding sub-set among the multiple sub-sets and a corresponding portion in the set of computing resources.

According to one implementation of the present disclosure, the executing module 930A is further configured to: execute a corresponding sub-set among the multiple sub-sets to obtain a processing sub-result by using a corresponding portion in the set of computing resources on the basis of a mapping relationship; and obtain the processing result on the basis of the processing sub-result.

According to one implementation of the present disclosure, the computing resource is a graphical processing unit, and the set of resource calling instructions is instructions executable to the graphical processing unit.

According to one implementation of the present disclosure, the apparatus 900A further comprises a scheduling module configured to: dynamically assign the set of resource calling instructions to a further set of computing resources on the basis of a workload of the set of computing resources; and execute the set of resource calling instructions to obtain a processing result by using the further set of computing resources.

According to one implementation of the present disclosure, the apparatus 900A further comprises a statistical module configured to make statistics on at least one of: the number of the set of computing resources, a time duration for which the at least one set of computing resources has been used, and a workload of the set of computing resources.

FIG. 9B schematically shows a block diagram of an apparatus 900B for processing a computing task according to one implementation of the present disclosure. Specifically, the apparatus 900B comprises: an establishing module 910B configured to establish a connection with a server on the basis of a processing request, the processing request being for requesting the allocation of a set of computing resources for processing the computing task; an executing module configured to execute the computing task, comprising: extracting a set of resource calling instructions from the computing task; sending the set of resource calling instructions to the server via the established connection; and receiving from the server a processing result of executing the set of resource calling instructions by the set of computing resources.

According to one implementation of the present disclosure, the establishing module 910B is further configured to: send the processing request to the server; and in response to receiving a connection configuration available to the processing result from the server, establish the connection with the server on the basis of the connection configuration.

According to one implementation of the present disclosure, the executing module 920B is further configured to: divide the set of resource calling instructions into multiple sub-sets based on demands on performance from various resource calling instructions in the set of resource calling instructions; determine a mapping relationship between a corresponding sub-set among the multiple sub-sets and a corresponding portion in the set of computing resources on the basis of the connection configuration; and sending a corresponding sub-set among the multiple sub-sets as well as the mapping relationship to the server, so that a corresponding portion in the set of computing resources execute a corresponding sub-set among the multiple sub-sets on the basis of the mapping relationship.

According to one implementation of the present disclosure, the processing result comprises a demand on the set of computing resources so as to select the set of computing resources that match the demand.

In one implementation of the present disclosure, there is provided a system for processing a computing task, comprising: one or more processors; a memory coupled to at least one processor of the one or more processors; computer program instructions stored in the memory which, when executed by the at least one processor, cause the system to execute a method for processing a computing task. The method comprises: establishing a connection with a client in response to receiving a processing request from the client, the processing request being for requesting the allocation of a set of computing resources for processing the computing task; receiving a set of resource calling instructions associated with the computing task from the client via the established connection; executing the set of resource calling instructions to obtain a processing result by using the set of computing resources; and returning the processing result to the client.

According to one implementation of the present disclosure, the establishing a connection with a client comprises: providing to the client a connection configuration available to the processing request on the basis of resource configuration information; and establishing the connection in response to a connection request initiated by the client on the basis of the connection configuration.

According to one implementation of the present disclosure, the processing request comprises a demand on the set of computing resources, and the providing to the client a connection configuration available to the processing request comprises: selecting computing resources that match the demand from the resource configuration information as the set of computing resources; and providing to the client a connection configuration for accessing the set of computing resources.

According to one implementation of the present disclosure, the method further comprises any of: in response to receiving an expansion request for adding a new computing resource, adding information associated with the new computing resource to the resource configuration information; and in response to receiving a removal request for removing an existing computing resource, removing information associated with the existing computing resource from the resource configuration information.

According to one implementation of the present disclosure, the receiving a set of resource calling instructions associated with the computing task from the client comprises: receiving multiple sub-sets of the set of resource calling instructions as well as a mapping relationship from the client, the multiple sub-sets resulting from dividing based on demands on performance from various resource calling instructions in the set of resource calling instructions, the mapping relationship specifying a mapping relationship between a corresponding sub-set among the multiple sub-sets and a corresponding portion in the set of computing resources.

According to one implementation of the present disclosure, the method further comprises: dividing the set of resource calling instructions received from the client into multiple sub-sets on the basis of demands on performance from various resource calling instructions in the set of resource calling instructions; specifying a mapping relationship between a corresponding sub-set among the multiple sub-sets and a corresponding portion in the set of computing resources.

According to one implementation of the present disclosure, the obtaining a processing result comprises: executing a corresponding sub-set among the multiple sub-sets to obtain a processing sub-result by using a corresponding portion in the set of computing resources on the basis of a mapping relationship; and obtaining the processing result on the basis of the processing sub-result.

According to one implementation of the present disclosure, the computing resource is a graphical processing unit, and the set of resource calling instructions is instructions executable to the graphical processing unit.

According to one implementation of the present disclosure, the method further comprises: dynamically assigning the set of resource calling instructions to a further set of computing resources on the basis of a workload of the set of computing resources; and executing the set of resource calling instructions to obtain a processing result by using the further set of computing resources.

According to one implementation of the present disclosure, the method further comprises making statistics on at least one of: the number of the set of computing resources, a time duration for which the at least one set of computing resources has been used, and a workload of the set of computing resources.

In one implementation of the present disclosure, there is provided a system for processing a computing task, comprising: one or more processors; a memory coupled to at least one processor of the one or more processors; computer program instructions stored in the memory which, when executed by the at least one processor, cause the system to execute a method for processing a computing task. The method comprises: establishing a connection with a server on the basis of a processing request, the processing request being for requesting the allocation of a set of computing resources for processing the computing task; executing the computing task, comprising: extracting a set of resource calling instructions from the computing task; sending the set of resource calling instructions to the server via the established connection; and receiving from the server a processing result of executing the set of resource calling instructions by the set of computing resources.

According to one implementation of the present disclosure, the establishing a connection with a server comprises: sending the processing request to the server; and in response to receiving a connection configuration available to the processing result from the server, establishing the connection with the server on the basis of the connection configuration.

According to one implementation of the present disclosure, the method further comprises: dividing the set of resource calling instructions into multiple sub-sets on the basis of demands on performance from various resource calling instructions in the set of resource calling instructions; determining a mapping relationship between a corresponding sub-set among the multiple sub-sets and a corresponding portion in the set of computing resources on the basis of the connection configuration; and sending the set of resource calling instructions to the server, comprising: sending a corresponding sub-set among the multiple sub-sets as well as the mapping relationship to the server, so that a corresponding portion in the set of computing resources execute a corresponding sub-set among the multiple sub-sets on the basis of the mapping relationship.

According to one implementation of the present disclosure, the processing result comprises a demand on the set of computing resources so as to select the set of computing resources that match the demand.

In one implementation of the present disclosure, there is provided a computer readable storage medium on which computer program instructions are stored, the computer program instructions, when executed, causing a machine to execute a method executed at the server side as described above.

In one implementation of the present disclosure, there are provided computer program instructions which, when executed, causing a machine to execute a method executed at the client side as described above.

The flowchart and block diagrams in the Figures illustrate the architecture, functionality, and operation of possible implementations of systems, methods and computer program products according to various implementations of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks illustrated in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

1. A method for processing a computing task, comprising:
establishing a connection with a client in response to receiving a processing request from the client, the processing request being for requesting an allocation of a set of computing resources for processing the computing task;
receiving a set of resource calling instructions associated with the computing task from the client via the established connection;
executing the set of resource calling instructions to obtain a processing result by using the set of computing resources; and
returning the processing result to the client.

2. The method according to claim 1, wherein the establishing a connection with a client comprises:
providing to the client a connection configuration available to the processing request on the basis of resource configuration information; and
establishing the connection in response to a connection request initiated by the client on the basis of the connection configuration.

3. The method according to claim 2, wherein the processing request comprises a demand on the set of computing resources, and the providing to the client a connection configuration available to the processing request comprises:
selecting computing resources that match the demand from the resource configuration information as the set of computing resources; and
providing to the client a connection configuration for accessing the set of computing resources.

4. The method according to claim 2, further comprising at least one of:
in response to receiving an expansion request for adding a new computing resource, adding information associated with the new computing resource to the resource configuration information; and
in response to receiving a removal request for removing an existing computing resource, removing information associated with the existing computing resource from the resource configuration information.

5. The method according to claim 1, wherein the receiving a set of resource calling instructions associated with the computing task from the client comprises:
receiving multiple sub-sets of the set of resource calling instructions as well as a mapping relationship from the client, the multiple sub-sets being divided based on demands on performance from various resource calling instructions in the set of resource calling instructions, the mapping relationship specifying a mapping relationship between a corresponding sub-set among the multiple sub-sets and a corresponding portion in the set of computing resources.

6. The method according to claim 1, further comprising:
dividing the set of resource calling instructions received from the client into multiple sub-sets based on demands on performance from various resource calling instructions in the set of resource calling instructions; and
specifying a mapping relationship between a corresponding sub-set among the multiple sub-sets and a corresponding portion in the set of computing resources.

7. The method according to claim 5 or 6, wherein the obtaining a processing result comprises:
executing a corresponding sub-set among the multiple sub-sets to obtain a processing sub-result by using a corresponding portion in the set of computing resources on the basis of a mapping relationship; and
obtaining the processing result on the basis of the processing sub-result.

8. The method according to claim 1, wherein the computing resource is a graphical processing unit, and the set of resource calling instructions is instructions executable to the graphical processing unit.

9. The method according to claim 1, further comprising:
dynamically assigning the set of resource calling instructions to a further set of computing resources on the basis of a workload of the set of computing resources; and
executing the set of resource calling instructions to obtain a processing result by using the further set of computing resources.

10. The method according to claim 1, further comprising making statistics on at least one of:
the number of the set of computing resources, a time duration for which the at least one set of computing resources has been used, and a workload of the set of computing resources.

11. A system for processing a computing task, comprising:
one or more processors;
a memory coupled to at least one processor of the one or more processors;
computer program instructions stored in the memory which, when executed by the at least one processor, cause the system to execute a method for processing a computing task, the method comprising:
establishing a connection with a client in response to receiving a processing request from the client, the processing request being for requesting an allocation of a set of computing resources for processing the computing task;
receiving a set of resource calling instructions associated with the computing task from the client via the established connection;
executing the set of resource calling instructions to obtain a processing result by using the set of computing resources; and
returning the processing result to the client.

12. The system according to claim 11, wherein the establishing a connection with a client comprises:
providing to the client a connection configuration available to the processing request on the basis of resource configuration information; and
establishing the connection in response to a connection request initiated by the client on the basis of the connection configuration.

13. The system according to claim 12, wherein the processing request comprises a demand on the set of computing resources, and the providing to the client a connection configuration available to the processing request comprises:
selecting computing resources that match the demand from the resource configuration information as the set of computing resources; and
providing to the client a connection configuration for accessing the set of computing resources.

14. The system according to claim 12, further comprising at least one of:
in response to receiving an expansion request for adding a new computing resource, adding information associated with the new computing resource to the resource configuration information; and
in response to receiving a removal request for removing an existing computing resource, removing information associated with the existing computing resource from the resource configuration information.

15. The system according to claim 11, wherein the receiving a set of resource calling instructions associated with the computing task from the client comprises:
receiving multiple sub-sets of the set of resource calling instructions as well as a mapping relationship from the client, the multiple sub-sets being divided based on demands on performance from various resource calling instructions in the set of resource calling instructions, the mapping relationship specifying a mapping relationship between a corresponding sub-set among the multiple sub-sets and a corresponding portion in the set of computing resources.

16. The system according to claim 11, wherein the method further comprises:
dividing the set of resource calling instructions received from the client into multiple sub-sets based on demands on performance from various resource calling instructions in the set of resource calling instructions; and
specifying a mapping relationship between a corresponding sub-set among the multiple sub-sets and a corresponding portion in the set of computing resources.

17. The system according to claim 15 or 16, wherein the obtaining a processing result comprises:
executing a corresponding sub-set among the multiple sub-sets to obtain a processing sub-result by using a corresponding portion in the set of computing resources on the basis of a mapping relationship; and
obtaining the processing result on the basis of the processing sub-result.

18. The system according to claim 11, wherein the computing resource is a graphical processing unit, and the set of resource calling instructions is instructions executable to the graphical processing unit.

19. The system according to claim 11, wherein the method further comprises:
dynamically assigning the set of resource calling instructions to a further set of computing resources on the basis of a workload of the set of computing resources; and
executing the set of resource calling instructions to obtain a processing result by using the further set of computing resources.

20. The system according to claim 11, wherein the method further comprises making statistics on at least one of:
the number of the set of computing resources, a time duration for which the at least one set of computing resources has been used, and a workload of the set of computing resources.

21-30. (canceled)
